(19) United States
(12) Patent Application Publication
(10) Pub. No.: US 2005/0005701 A1
(43) Pub. Date: Jan. 13, 2005

(54) Pressure measuring apparatus and pressure sensor thereof

(75) Inventor: Andrew Cheng, Tao Yuan (TW)

Correspondence Address: BRUCE H. TROXELL, SUITE 1404, 5205 LEESBURG PIKE, FALLS CHURCH, VA, 22041, US

(73) Assignee: Signal Electronic Co., Ltd.

(21) Appl. No.: 10/726,704

(22) Filed: Dec. 4, 2003

(30) Foreign Application Priority Data
Jul. 11, 2003 (TW) 92212701

(51) Int. Cl. G01L 19/04

(52) U.S. Cl. 73/708

(57) ABSTRACT

the present invention relates to a pressure measuring apparatus having a major technique signature of using only one resistor, wherein while measuring an external stress using the apparatus, an oscillating signal is received at an end of the resistor which is affected by the external stress, and consequently the affected resistor will have effect on the oscillating signal which is outputted from the other end of the resistor thereafter. Hence, the present invention provides a pressure measuring apparatus and a pressure sensor thereof using the frequency difference of the oscillating signal in accordance to the variation of the resistor value as base for measuring the external stress. Hence, the present invention requires no amplifier and A/D converter so that the whole manufacturing process is simplified and also the overall cost of the pressure measuring apparatus is reduced.

### BACKGROUND OF THE INVENTION

(a). Field of the Invention

The present invention relates to a pressure measuring apparatus and a pressure sensor thereof, more particularly, to a pressure measuring apparatus and a pressure sensor thereof employing only one resistor as pressure sensor.

(b). Description of the Prior Arts

The working principle of pressure sensors currently available on the market, such as tire gauge, etc., is based on that the resistor buried in the pressure sensor will present different characteristics in accordance to the stress applied on the sensor. Please refer to FIG. 1A and FIG. 1B, which are respectively a side view and a sectional view schematically depicting a pressure sensor of the prior art. As seen in FIG. 1A, the pressure sensor 100 has four resistors 121-127 located on the top 115 of the substrate 110, moreover, as seen in FIG. 1B, a recess 129 is located at the center of the bottom 120 of the substrate 110, wherein the two resistors 123, 127 located on the top 115 of the substrate 110 are arranged intentionally at the places which are opposite to the two side of the recess 129.

Therefore, when an external stress is applied on the top 115 of the pressure sensor's 100 substrate 110, the external stress will be concentrated toward the area on the top 115 of the substrate 110 which is direct opposite to the recess 129 of the substrate 110, i.e. the area between the resistor 123 and the resistor 125 on the top 115 of the substrate 110. In this regard, the characteristics of the resistors 123, 125 are prone to be changed while receiving an external stress. But, on the other hand, the resistors 121, 127 are not. Thus, when an electric bridge is formed using the four resistors 121-127, the changes happened in the resistor 123 and the resistor 125 will cause a voltage difference to happen between the two nodes of the electric bridge so that the magnitude of the external stress can be measured accordingly.

Please refer to FIG. 2, which is a circuitry depicting a pressure measuring apparatus in accordance to the prior art. As seen in FIG. 2, the pressure measuring apparatus 200 is controlled by an user using the human-machine interface 210 by which the user can control the system oscillator 220 to generate a working frequency for the whole pressure measuring circuitry 200, i.e. to generate a working frequency for controlling the components in the pressure measuring circuitry 200, which are an amplifier 230, an analogue to digital converter (A/D converter) 240, a numerical converter 250 and a display controller 270. Yet, the pressure sensor 260 within the pressure measuring apparatus 200 uses the resistors 121-127 of FIG. 1 to form an electric bridge, wherein the resistors 121-127 have identical characteristics and resistor values before measuring an external stress.

Hence, when the pressure sensor 260 is connected with a reference voltage V_{DD} for measuring an external stress, the external stress will cause the characteristics and the resistor values of the two resistor 123, 125 to change and subsequently have affect on the voltages over the two resistors 123, 125, moreover, the voltages on node 1 will also be different from the voltages on node 2. In order to use the voltage difference between the two nodes, i.e. node 1 and node 2, the voltage signal 261 of node 1 and the voltage signal 262 of node 2 are amplified by the amplifier 230 to become the signals 265, 267 that can be received by the A/D converter 240. Afterward, the foregoing analogue signals 265, 267 are converted by the A/D converter 240 to become the digital signals 269, 271 for proceeding with table lookup in the numerical converter 250.

After the digitized voltage signal 269 of node 1 and voltage signal 271 of node 2 are compared using the lookup table of the numerical converter 250, an signal 273 representing the magnitude of the external stress can be acquired using the voltage difference between the node 1 and the node 2. Finally, the external stress value signal 273 is outputted to the monitor 280 through the display controller 260 for showing the measured magnitude of the external stress on the monitor 280.

However, the pressure measuring apparatus 200 of the prior art has the following shortcomings:
1. The voltages on the node 1 and the node 2 are small voltages that will change in response to external stresses, moreover, small voltage variation will require to be amplified using the amplifier 230 before it is capable of being converted into digital signals. Thus, before converting the analogue signals of the voltages on the node 1 and the node 2, the voltages on the node 1 and the node 2 have to be amplified using the amplifier 230 to an extent that the A/D converter 240 can receive.
2. The amplifier 230 is a component having characteristics of high electricity consumption and high cost. Thus, the produces using the aforementioned pressure measuring apparatus 200 are not portable because of the characteristic of high electricity consumption will result in the apparatus 200 is incapable of using ordinary batteries, moreover, the high cost of the amplifier 230 will cause the produces using the aforementioned pressure measuring apparatus 200 to have no competitiveness in the industry.
3. Similar condition is also happening to the A/D converter 240 that the production cost thereof is high because of the high production precision requirement. Thus, the A/D converter 240 will cause the produces using the aforementioned pressure measuring apparatus 200 to suffer the same industrial competition problem.

In view of this, the present invention provides a pressure measuring apparatus and a pressure sensor thereof using no amplifier and A/D converter so as to reduce the whole production cost of the pressure measuring circuitry.

### SUMMARY OF THE INVENTION

The primary object of the present invention is to provide a pressure sensor having a major technique signature of using only one resistor, wherein while measuring an external stress using the pressure sensor, an oscillating signal is received at an end of the resistor which is affected by the external stress, and consequently the affected resistor will have effect on the oscillating signal outputted from the other end of the resistor thereafter.

Another object of the present invention is to provide a pressure measuring apparatus using the foregoing pressure sensor, comprising a first resistor and a pressure measuring circuitry, wherein the pressure measuring circuitry generates a first oscillating signal between the first end and the second end of the first resistor. Hence, when the first resistor is affected by an external stress and outputs a first oscillating signal corresponding to the variation of the external stress from its second end, the pressure measuring circuitry will be able to measure the external stress basing on the first oscillating signal.

In a preferred embodiment of the present invention, one end of the first resistor is serial connected to an oscillating signal controller, and the second end of the first resistor is serial connected to a capacitance which is ground connected. The oscillating signal controller along with the capacitance will generate a first oscillating signal between the first end and the second end of the first resistor.

In the preferred embodiment of the present invention, the pressure measuring circuitry not only comprises the aforementioned oscillating signal controller and the capacitance, but further comprises a second resistor, a numerical converter, a display controller, a monitor, a human-machine interface and a system oscillator. Wherein, the first end of the second resistor is coupled to the node where the first resistor is coupled to the capacitance, and the second end of the second resistor is coupled to the oscillating signal controller using an input terminal which is different from the one used by the first resistor. The second resistor will not be affected by the external stress, i.e. the oscillating signal controller along with the capacitance will generate a second oscillating signal between the first end and the second end of the second resistor, and the second oscillating signal is not going to be affected by the variation of external stress.

The numerical converter will receive and compare the first oscillating signal and the second oscillating signal so as to output a data signal thereafter. The display controller then receives the data signal outputted from the numerical converter and transfer thereof to the monitor. Finally, the monitor receives and displays the data signal coming from the display controller.

Furthermore, the whole pressure measuring apparatus primarily is operated by a user using a control signal issued by means of the human-machine interface so as to activate oscillating signals needed for generating outputs of the pressure measuring apparatus, moreover, the oscillating signals will be send to the oscillating signal controller, the numerical converter and the display controller.

To sum up, the present invention provides a pressure measuring apparatus and a pressure sensor thereof using no amplifier and A/D converter so as to reduce the overall cost of the pressure measuring circuitry.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits and advantages of the preferred embodiments of the present invention will be readily understood by the accompanying drawings and detailed descriptions, wherein:

FIG. 1A is a side view schematically depicting a pressure sensor of the prior art.

FIG. 1B is a sectional view schematically depicting a pressure sensor of the prior art.

FIG. 2 is a circuitry depicting a pressure measuring apparatus in accordance to the prior art.

FIG. 3A is a side view schematically depicting a pressure sensor according to a preferred embodiment of the present invention.

FIG. 3B is a sectional view schematically depicting a pressure sensor according to a preferred embodiment of the present invention.

FIG. 4 is a circuitry depicting a pressure measuring apparatus according to a preferred embodiment of the present invention.

### DETAILED DESCRIPTION OF THE PRESENT INVENTION

The following embodiments will illustrate the device and the method for processing the digital image of the present invention in detail.

Current pressure measuring apparatus generally employs electric bridge formed with resistors as pressure sensor. When the electric bridge is subjected to an external stress, the electric bridge will generate a small voltage proportional to the external stress. The small voltage is required to be amplified by an amplifier so that it can be received and converted by an A/D converter to a digital signal. The digital signal is then transformed into a data signal using a numerical converter. Finally, the data signal is displayed on a monitor showing the magnitude of the external stress that is comprehensible for a user. However, using the pressure measuring apparatus of the prior art to measure an external stress requires transforming a small voltage variation into a digital signal using a amplifier and an A/D converter, and consequently the electric consumption of the pressure measuring apparatus of the prior art is high so that the foregoing apparatus is not portable since using battery as power source of the apparatus is impossible, furthermore, the amplifier and the A/D converter used in the foregoing apparatus will greatly increase its production cost.

Therefore, the present invention uses an oscillating signal as the signal source of the pressure measuring apparatus accordingly. That is, by means of one characteristic of resistor that the resistor value thereof will vary while subjecting to an external stress, and also the oscillating signal will vary in frequency and the variation of frequency is in proportion to the variation of the resistor value, thus, the external stress can be measured by measuring the variation of the oscillating signal frequency. Therefore, the pressure measuring apparatus of the present invention will require only one resistor and will have no need for amplifier and A/D converter.

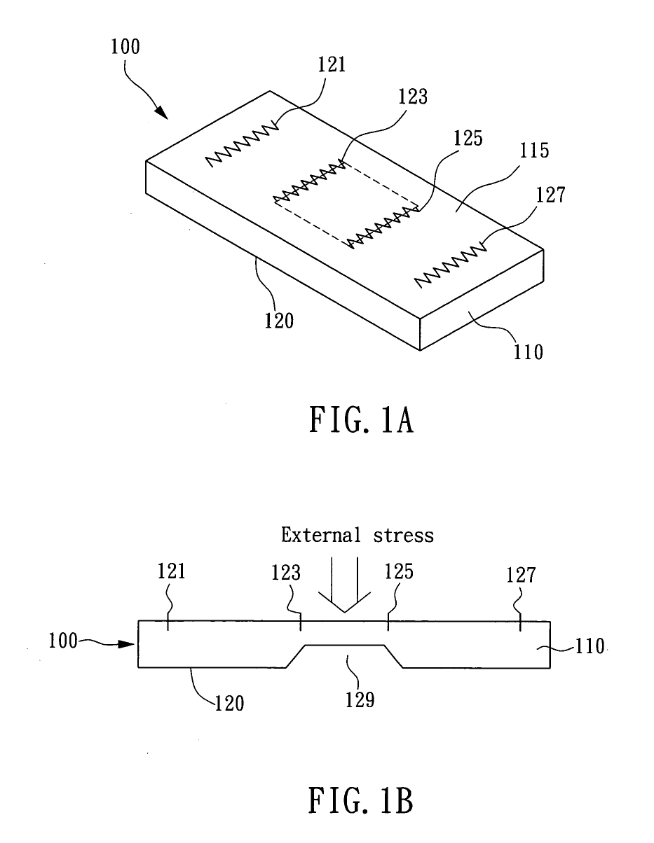

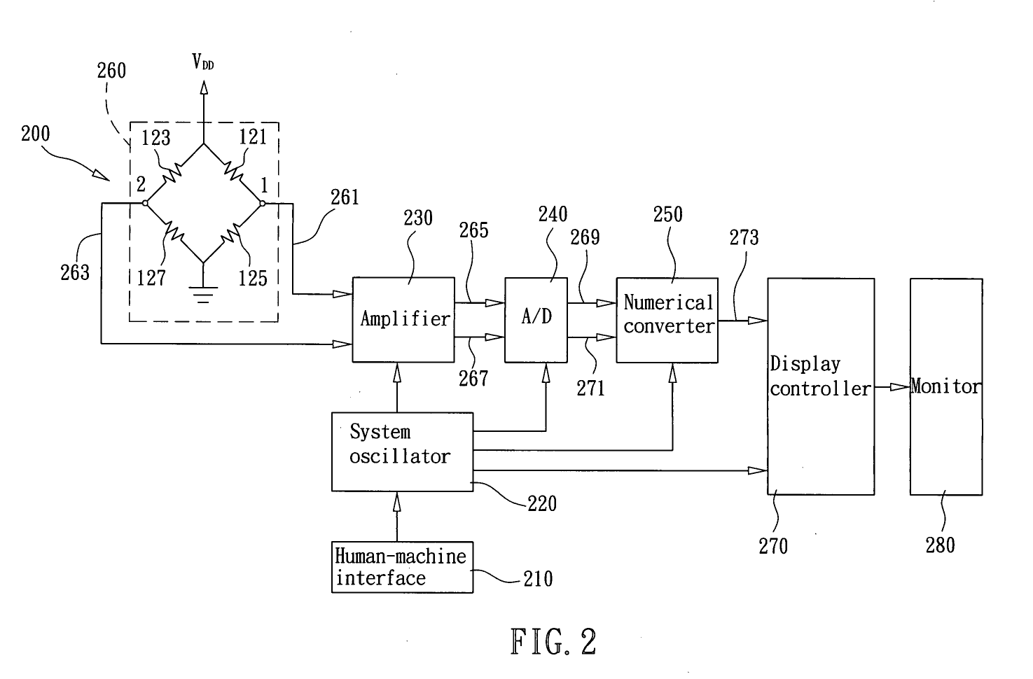

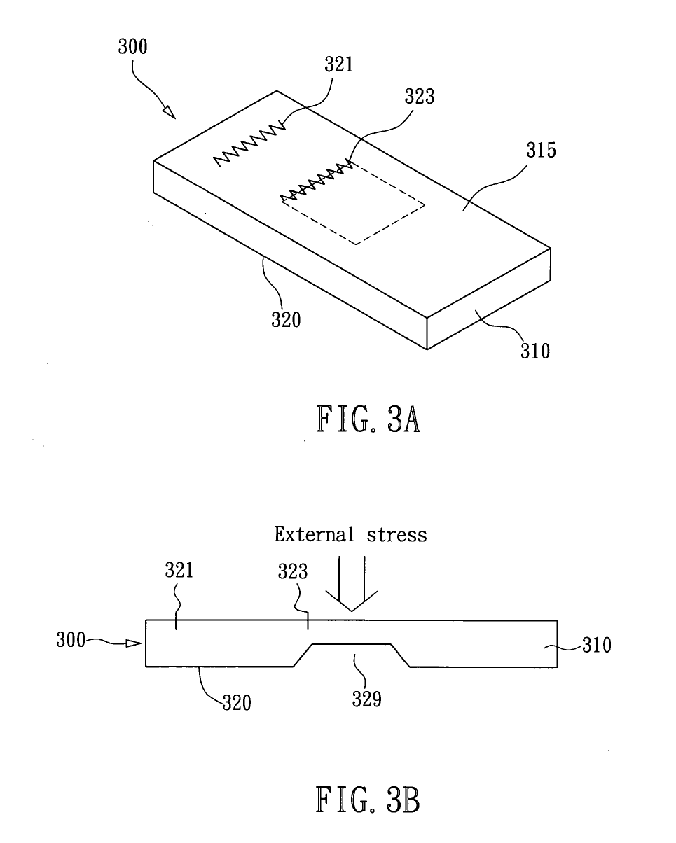

Please refer to FIG. 1A and FIG. 1B, which are respectively a side view and a sectional view schematically depicting a pressure sensor of the present invention. As seen in FIG. 3A, the pressure sensor 300 is roughly similar to the pressure sensor 100 of FIG. 1A, and as seen in FIG. 3B, a recess 329 is also similarly located at the center of the bottom 320 of the substrate 310. What's different is that the pressure sensor 300 has only one resistor 323 located on the top 315 of the substrate 310 corresponding to one side of the recess 329 for measuring the external stress. On the other hand, the resistor 321 located at a side of the resistor 323 is user as a stationary resistor for comparing with the resistor 323 while subjecting to an external stress.

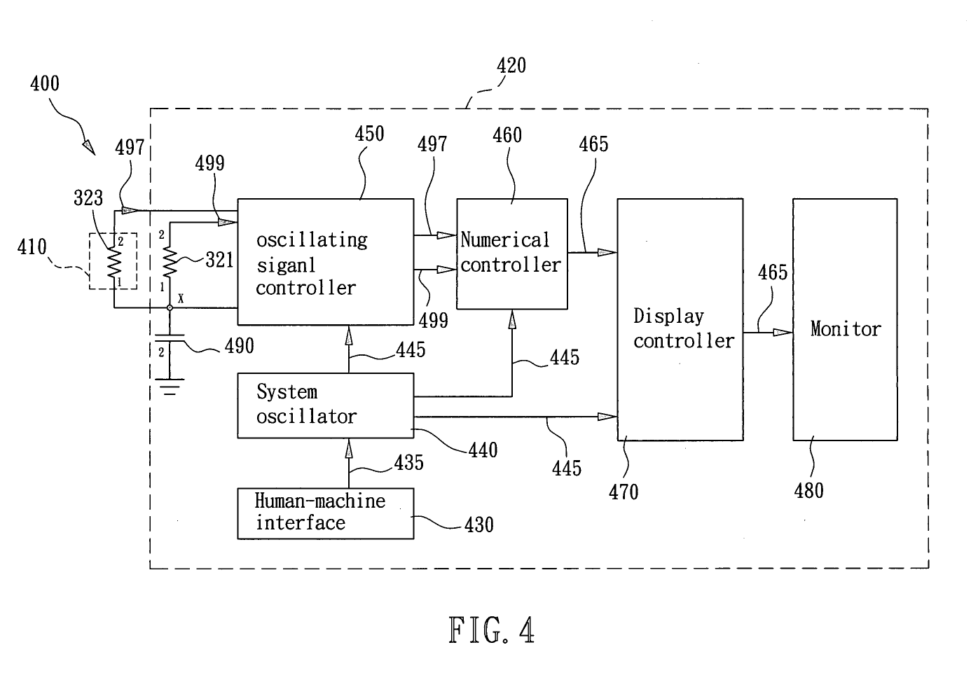

Please refer to FIG. 4, which is a circuitry depicting a pressure measuring apparatus according to a preferred embodiment of the present invention. The pressure measuring apparatus 400 mainly is composed of a pressure sensor 410 and a pressure measuring circuitry 420. Wherein, the pressure sensor is the resistor 323 of FIG. 3A, and the pressure measuring circuitry 420 is composed using: a human-machine interface 430, a system oscillator 440, an oscillating signal controller 450, a numerical converter 460, a display controller 470, a monitor 480, a capacitance 490 and the resistor of FIG. 3A.

Since a human-machine interface 430 is used in the pressure measuring apparatus 400, a user can control the whole pressure measuring apparatus 400 using the human-machine interface 430. When the pressure measuring apparatus 400 is used by a user, the user can input a control signal 435 to the system oscillator 440 using the human-machine interface 430 so as to enable the system oscillator 440 to generate system oscillating signals 445 for used as an working frequency of the pressure measuring circuitry 420. Hence, the system oscillating signals 445 are outputted from the system oscillator 440 to the oscillating signal controller 450, the numerical converter 460, and the display controller 470.

Since in the preferred embodiment of the present invention, the resistor 323 is used as pressure sensor, and the resistor 321 is used as reference for comparing with the resistor 323 subjecting to an external stress. In this regard, the first end of the resistor 323, the first end of the resistor 321, the first end of the capacitance 490 are all coupled to the node x, and the second end of the resistor 323 and the second end of the resistor 321 respectively is connected to two different input terminals of the oscillating signal controller 450, moreover, the resistor 323 and the resistor 321 are the same in characteristic and have the same resistor value.

Hence, when the pressure measuring apparatus 400 is used by a user through the human-machine interface 430, the circuit between the oscillating signal controller 450 and the second end of the capacitance 490 which is ground connected will generates a first oscillating signal 497 at the place between the first end and the second end of the resistor 323 by way of the oscillating signal controller 450 and the capacitance 490, wherein the resistor 323 will be affected by an external stress so as to output an first oscillating signal 497 varied in proportion to the external stress from the second end of the resistor 323. Simultaneously, the oscillating signal controller 450 and the capacitance 490 will also generate a second oscillating signal 499 at the place between the first end and the second end of the resistor 321. However, the second oscillating signal 499 is configured in the way that it will not vary with the external stress, so that an stationary second oscillating signal 499 is outputted from the second end of the resistor 321.

In another word, when the pressure measuring apparatus 400 is used by a user that the pressure sensor 410, i.e. the resistor 323, inside the apparatus 400 is used for measuring an external stress, the external stress will vary the resistor value of the resistor 323. Thus, during the measuring process, the frequency of the first oscillating signal 497 generated by the oscillating signal controller 450 and the capacitance 490 between the first end and the second end of the resistor 323 will change in accordance to the variation of the external stress, the same time that the frequency of the second oscillating signal 499 also generated by the oscillating signal controller 450 and the capacitance 490 between the first end and the second end of the resistor 321, on the contrary, will not change with the variation of the external stress.

After the oscillating signal controller 450 receives the first oscillating signal 497 and the second oscillating signal 499 inputted respectively from the second end of the resistor 323 and the second end of the resistor 321, the oscillating signal controller 450 will transmit the two oscillating signals 497, 499 to the numerical converter 460.

When the two oscillating signals 497, 499 transmitted from the oscillating signal controller 450 are received by the numerical converter 460, the process of table lookup can be proceeded basing on the frequencies of the two oscillating signals 497, 499 for acquiring a data signal 465 representing the magnitude of the external stress. The principle of the aforementioned process is as the following description: Before an external stress is applied on the pressure measuring apparatus 400, the resistor 323 and the resistor 321 have the same characteristic and resistor value so that the oscillating signals respectively generated by the oscillating signal controller 450 and the capacitance 490 between the two ends of the resistor 323 and the two ends of the resistor 32 will have the same frequency. However, when an external stress is applied on the pressure measuring apparatus 400, the same oscillating signal controller 450 and the same capacitance 490 are still used to generate oscillating signals both on the resistor 323 and the resistor 321 simultaneously, but the resistor 323 is used as a pressure sensor that the resistor value thereof will change in proportion to the external stress, moreover, the resistor 321 is employed as a reference that the resistor value thereof will not change in accordance to the external stress. Therefore, as mentioned before, the frequency of the first oscillating signal 497 generated by the oscillating signal controller 450 and the capacitance 490 between the first end and the second end of the resistor 323 will change in accordance to the variation of the external stress, the same time that the frequency of the second oscillating signal 499 also generated by the oscillating signal controller 450 and the capacitance 490 between the first end and the second end of the resistor 321, on the contrary, will not change with the variation of the external stress.

In this regard, the frequency difference between the first oscillating signal 497 and the second oscillating signal 499 is the result of the resistor value difference between the resistor 323 and the resistor 321 while measuring an external stress, moreover, the resistor value difference between the resistor 323 and the resistor 321 while measuring an external stress is caused by the external stress. Thus, the magnitude of the frequency difference between the two oscillating signals 497, 499 is directly proportional to the magnitude of the external stress.

Thus, when the two oscillating signals 497, 499 transmitted from the oscillating signal controller 450 are received by the numerical converter 460, the process of table lookup can be proceeded basing on the frequencies of the two oscillating signals 497, 499 for acquiring a data signal 465 representing the magnitude of the external stress.

The data signal 465 is then transmitted into the monitor 480 through the display controller 470 for showing a picture representing the magnitude of the external stress so that the user can comprehend the magnitude of the external stress measured using the pressure measuring apparatus 400.

The preferred embodiment of the present invention uses the resistor 323 whose resistor value can be affected by an external stress, moreover, the affected resistor value of the resistor 323 will have effect on the frequency of the oscillating signal 497 happening in the circuit between the capacitance 490, the resistor 323 and the oscillating signal controller 450 so that the oscillating signal 497 will not be the same as the oscillating signal 499 happening in the circuit between the capacitance 490, the resistor 321 and the oscillating signal controller 450. Therefore, the pressure measuring apparatus of the present invention is a pressure measuring apparatus utilizing the variation of resistor value to change the frequency of the oscillating signal (R to F), and has advantages as following:
1. The present invention uses the frequency difference of the oscillating signal as base for measuring the external stress, which is different from the apparatus of the prior art using the voltage difference as base for measuring the external stress. Thus, the present invention provides a pressure measuring apparatus using no amplifier and A/D converter so as to reduce the overall cost of the pressure measuring apparatus.
2. Since the present invention uses no amplifier and A/D converter, the electric consumption is reduced and therefore ordinary batteries can be used as power source of the present invention. Consequently, the present invention is portable.
3. Since the present invention uses the frequency difference of the oscillating signal as base for measuring the external stress, the pressure sensor of the present invention can be a single resistor that simplifies the manufacturing process of the pressure measuring apparatus.
4. Since the present invention has lower cost and simplified manufacturing process comparing to the prior art, the present invention can be mass-produced with lower cost.

To sum up, the present invention provides a pressure measuring apparatus and a pressure sensor thereof using the frequency difference of the oscillating signal in accordance to the variation of the resistor value as base for measuring the external stress. Hence, the present invention requires no amplifier and A/D converter so that the whole manufacturing process is simplified and also the overall cost of the pressure measuring apparatus is reduced.

1. A pressure sensor having a major technique signature of using only one resistor, wherein while measuring an external stress using the pressure sensor, an oscillating signal is received at an end of the resistor which is affected by the external stress, and consequently the affected resistor will have effect on the oscillating signal outputted from the other end of the resistor thereafter.

2. The pressure sensor of claim 1, wherein one end of the resistor is serial connected to an oscillating signal controller, and the other end of the resistor is serial connected to a capacitance which is ground connected, moreover, the oscillating signal controller along with the capacitance will generate the oscillating signal received by the resistor.

3. A pressure measuring apparatus, comprising:
a first resistor, having a first end and a second end; and
a pressure measuring circuitry, which generates a first oscillating signal between the first end and the second end of the first resistor;
wherein the first resistor is affected by an external stress and outputs a first oscillating signal corresponding to the variation of the external stress at the second end of the first resistor, and therefore the pressure measuring circuitry will be able to measure the magnitude of the external stress basing on the variation of the the first oscillating signal.

4. The pressure measuring apparatus of claim 3, wherein the pressure measuring circuitry further comprising:
a capacitance, having a first end and a second end, wherein the first end of the capacitance is coupled to the first end of the first resistor on a node, and the second end of the capacitance is ground connected; and
an oscillating signal controller, having a first input terminal and a second input terminal, wherein the first input terminal of the oscillating signal controller is coupled to the second end of the first resistor;
wherein the oscillating signal controller along with the capacitance will generates the first oscillating signal at the place between the first end and the second end of the first resistor.

5. The pressure measuring apparatus of claim 4, wherein the pressure measuring circuitry further comprising:
a second resistor, having a first end coupled to the node and a second end coupled to the second input terminal of the oscillating signal controller, that the second resistor will not be affected by the external stress, moreover, the oscillating signal controller along with the capacitance will generate a second oscillating signal between the first end and the second end of the second resistor, and the second oscillating signal is not going to be affected by the variation of external stress;
a numerical converter, which receives and compares the first oscillating signal and the second oscillating signal both transmitted from the oscillating signal controller so as to output a data signal thereafter;
a display controller, which receives and outputs the data signal outputted from the numerical converter;
a monitor, which receives and displays the data signal coming from the display controller;
a human-machine interface, controlled by a user to issue a control signal; and
a system oscillator, which receives the control signal so as to generate a series of system oscillating signals sent to the oscillating signal controller, the numerical converter and the display controller.

6. The pressure measuring apparatus of claim 5, wherein the first resistor and the second resistor possess the same resistor values.

7. The pressure measuring apparatus of claim 6, further comprising:
a plurality of the second resistors, respectively having a first end coupled to the node and a second end coupled to the second input terminal of the oscillating signal controller.

8. A pressure measuring apparatus, comprising:
a first resistor, having a first end and a second end;
a capacitance, having a first end and a second end, wherein the first end of the capacitance is coupled to the first end of the first resistor on a node, and the second end of the capacitance is ground connected;
a second resistor, having a first end and a second end, wherein the first end is coupled to the node;
an oscillating signal controller, having a first input terminal and a second input terminal, wherein the first input terminal of the oscillating signal controller is coupled to the second end of the first resistor and the second input terminal of the oscillating signal controller is coupled to the second end of the second resistor, moreover, the oscillating signal controller along with the capacitance will generates the first oscillating signal at the place between the first end and the second end of the first resistor and a second oscillating signal at the place between the first end and the second end of the second resistor, thus, the first resistor affected by an external stress outputs the first oscillating signal affected by the variation of the external stress from the second end of the first resistor, and the unaffected second resistor outputs the second oscillating signal unaffected by the variation of the external stress from the second end of the second resistor;
a numerical converter, which receives and compares the first oscillating signal and the second oscillating signal both outputted by the oscillating signal controller so as to output a data signal thereafter;
a display controller, which receives and outputs the data signal outputted from the numerical converter;
a monitor, which receives and displays the data signal coming from the display controller;
a human-machine interface, controlled by a user to issue a control signal; and
a system oscillator, which receives the control signal so as to generate a series of system oscillating signals sent to the oscillating signal controller, the numerical converter and the display controller.

9. The pressure measuring apparatus of claim 8, further comprising:
a plurality of the second resistors, respectively having a first end coupled to the node and a second end coupled to the second input terminal of the oscillating signal controller.
